(19) United States
(12) Patent Application Publication
(10) Pub. No.: US 2014/0038142 A1
(43) Pub. Date: Feb. 6, 2014

(54) INTERACTIVE TYPE LANGUAGE LEARNING PLATFORM SYSTEM

(71) Applicant: CHICOVERY CO., LTD., New Taipei City (TW)

(72) Inventor: JEN-CHI CHANG, Taipei City (TW)

(73) Assignee: CHICOVERY CO., LTD., New Taipei City (TW)

(21) Appl. No.: 13/648,912

(22) Filed: Oct. 10, 2012

(30) Foreign Application Priority Data
Aug. 3, 2012 (TW) 101128125

(51) Int. Cl. G09B 19/00

(52) U.S. Cl. 434/156

(57) ABSTRACT

The present invention discloses an interactive type language learning platform system applied to a display device. The interactive type language learning platform system comprises a learning interface and a video playback interface. The learning interface comprises a plurality of video options. The video playback interface comprises a video display zone and a subtitle display zone. When one of the video options is selected, the video playback zone displays video data in correspondence with the video option. The subtitle display zone synchronously displays a plurality of multi-language subtitle data in correspondence with the video date and a multi-language subtitle option respectively in correspondence with the multi-language subtitle data. When one of the multi-language subtitle options is selected, the video display zone displays a time position of the video data in correspondence with the multi-language subtitle option. Hereby, the present invention achieves the purpose of the interactive type language learning.

### CROSS-REFERENCE TO RELATED APPLICATION

This application claims the benefit of Taiwan Patent Application No. 101128125, filed on Aug. 3, 2012, in the Taiwan Intellectual Property Office, the disclosure of which is incorporated herein in its entirety by reference.

### FIELD OF THE INVENTION

The present invention relates to an interactive type language learning platform system, in particular to the interactive type language learning platform system applied to a set-top box or a Smart television.

### BACKGROUND OF THE INVENTION

In modern society, most people need to have a second or third language to have better development opportunities in life or work. As science and technology advance, the language learning tends to be developed diversely. For example, we can learn a language by listening to teaching videos, watching teaching videos, listening to foreign songs or appreciating foreign movies. Since the language learning through watching movies also provides the pressure releasing effect, such method arouses the learning interest of learners and becomes increasingly more popular.

However, when we learn a language through watching movies and wants to repeat browsing a certain specific subtitle and its pronunciation, we need to search for this section from the clips of the movie one by one, and it is inconvenient to repeat playing this clip, and thus creating tremendous inconvenience to language learning. On the other hand, when a certain dialogue has a new word, it requires an additional too such as an electronic device with the dictionary function or a physical dictionary, and learners require preparing the additional tool, thus bringing tremendous inconvenience to learners. In addition, the learners cannot look up a dictionary immediately, so that the learning efficiency is affected significantly.

In view of the aforementioned problems, the inventor of the present invention designed an interactive type language learning platform system to overcome the drawbacks of the prior art and improve the industrial applications.

### SUMMARY OF THE INVENTION

In view of the shortcomings of the prior art, it is a primary objective of the present invention to provide an interactive type language learning platform system to overcome the inconvenience and low efficiency of language learning.

According to the objective of the present invention, the present invention provides an interactive type language learning platform system applied to a display device by a data processing device and a storage device. The interactive type language platform comprises a learning interface and a video playback interface. The learning interface arranged for being executed from the storage device by the data processing device and displayed on at least a portion of the display device. The learning interface comprises a plurality of video options. The video playback interface arranged for being executed from the storage device by the data processing device and displayed on at least a portion of the display device. The video playback interface comprises a video display zone and a subtitle display zone. When one of the video options is selected, the selected video option is connected to the video playback interface, and the video display zone displays video data corresponding to the video option. The subtitle display zone synchronously displays a plurality of multi-language subtitle data corresponding to the video data and a multi-language subtitle option corresponding to the plurality of multi-language subtitle data. When one of the multi-language subtitle options is selected, the video display zone displays a time position of the video data corresponding to the multi-language subtitle option.

Preferably, the video playback interface further comprises a dictionary option. When the dictionary option and one of the multi-language subtitle options are selected, the video display zone displays sentence data corresponding to the multi-language subtitle option.

Preferably, each of the sentence data comprises at least one vocabulary option and vocabulary data corresponding to the at least one vocabulary option, and when the vocabulary option is selected, the video display zone displays the vocabulary data corresponding to the vocabulary option.

Preferably, the video playback interface further comprises a favorite option. When the favorite option and one of the multi-language subtitle options are selected, the sentence data or the multi-language subtitle data corresponding to the multi-language subtitle option are saved in a database.

Preferably, the interactive type language learning platform system further comprises a look-up interface; the look-up interface arranged for being executed from the storage device by the data processing device and displayed on at least a portion of the display device; the video playback interface further comprises a favorite inquiry option. When the favorite inquiry option is selected, the look-up interface is connected to display the sentence data or the multi-language subtitle data of the database.

Preferably, the interactive type language learning platform system further comprises a selected test interface, and the video playback interface further comprises a test option. The selected test interface arranged for being executed from the storage device by the data processing device and displayed on at least a portion of the display device. When the test option is selected, the selected test interface is connected.

Preferably, the interactive type language learning platform system further comprises a test interface, and the selected test interface further comprises a plurality of test subject options. The test interface arranged for being executed from the storage device by the data processing device and displayed on at least a portion of the display device. Each test subject option comprises at least one test question option, and the test question option is connected to the test interface.

Preferably, the plurality of test subject options comprise the test subject option corresponding to the video data and the test subject option having a preset test question.

Preferably, interactive type language learning platform system further comprises a score interface, and the video playback interface further comprises a score inquiry option. The score interface arranged for being executed from the storage device by the data processing device and displayed on at least a portion of the display device. The score inquiry option connects to the score interface to display score data.

Preferably, each of the score data comprises a score of a test taken by a user through the test interface.

With the aforementioned description, the interactive type language learning platform system of the present invention has one or more of the following advantages:

(1) In the interactive type language learning platform system of the present invention, the multi-language subtitle option is selected, so that the video display zone displays the time position of the video data corresponding to the multi-language subtitle option to improve the learning efficiency effectively.

(2) In the interactive type language learning platform system of the present invention, after the multi-language subtitle option and the dictionary option are selected, corresponding the sentence data are displayed in the video display zone to improve the convenience of learning.

(3) In the interactive type language learning platform system of the present invention, when the multi-language subtitle option and the favorite option are selected, the sentence data or the multi-language subtitle data are saved in the database to improve the convenience of revision effectively.

### BRIEF DESCRIPTION OF THE DRAWINGS

FIG. 1 is a block diagram of an interactive type language learning platform system in accordance with the present invention;

FIG. 2 is a first schematic view of an interactive type language learning platform system in accordance with a preferred embodiment of the present invention;

FIG. 3 is a second schematic view of an interactive type language learning platform system in accordance with a preferred embodiment of the present invention;

FIG. 4 is a third schematic view of an interactive type language learning platform system in accordance with a preferred embodiment of the present invention;

FIG. 5 is a fourth schematic view of an interactive type language learning platform system in accordance with a preferred embodiment of the present invention;

FIG. 6 is a fifth schematic view of an interactive type language learning platform system in accordance with a preferred embodiment of the present invention;

FIG. 7 is a sixth schematic view of an interactive type language learning platform system in accordance with a preferred embodiment of the present invention; and

FIG. 8 is a seventh schematic view of an interactive type language learning platform system in accordance with a preferred embodiment of the present invention.

### DESCRIPTION OF THE PREFERRED EMBODIMENTS

The technical characteristics of the present invention will become apparent with the detailed description of the preferred embodiments accompanied with the illustration of related drawings as follows. It is noteworthy that same numerals are used for representing the same respective elements in the drawings, and the drawings are provided for the purpose of illustrating the invention, but not intended for limiting the scope of the invention.

The interactive type language learning platform system of the present invention can be applied to a display device by a data processing device and a storage device, wherein the display device can be a television with a set-top box, a Smart television or the device with the display function, and the following embodiment adopts the Smart television for illustrating the present invention, but the invention is not limited to the Smart television only.

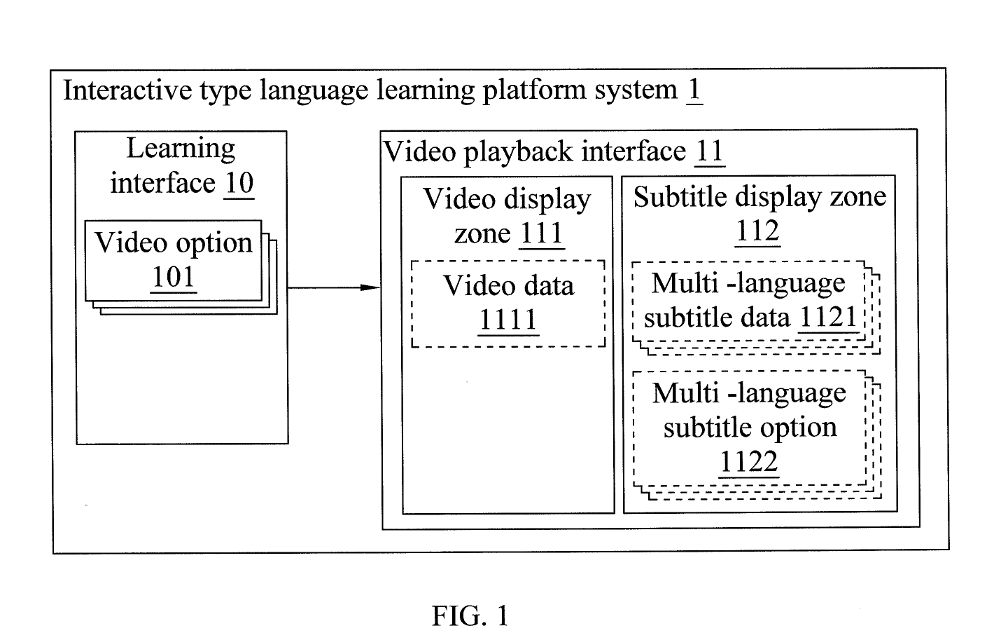

With reference to FIG. 1 for the block diagram of an interactive type language learning platform system of the present invention, the interactive type language learning platform system 1 comprises a learning interface 10 and a video playback interface 11. The learning interface 10 and the video playback interface 11 arranged for being executed from the storage device by the data processing device and displayed on at least a portion of the display device. Wherein, the learning interface 10 includes a plurality of video options 101. The video playback interface 11 includes a video display zone 111 and a subtitle display zone 112. When one of the video options 101 is selected, the learning interface 10 is connected to the video playback interface 11. Then, the video display zone 111 displays video data 1111 corresponding to the video option 101, and the subtitle display zone 112 synchronously displays a plurality of multi-language subtitle data 1121 corresponding to the video data 1111 and a multi-language subtitle option 1122 corresponding to the plurality of multi-language subtitle data 1121. If one of the multi-language subtitle options 1112 is selected, the video display zone 111 displays the time of the video data 1111 corresponding to the multi-language subtitle option 1121.

Simply speaking, if the multi-language subtitle option 1112 selected by a user and corresponding to the multi-language subtitle option 1112 the multi-language subtitle data 1121 are situated at 3 minutes and twenty seconds, then the video display zone 111 changes its display to the video data 1111 at the position of 3 minutes and 20 seconds. Therefore, the user has interactions with the interactive type language learning platform system 1 to repeat browsing the desired learning multi-language subtitle data 1121.

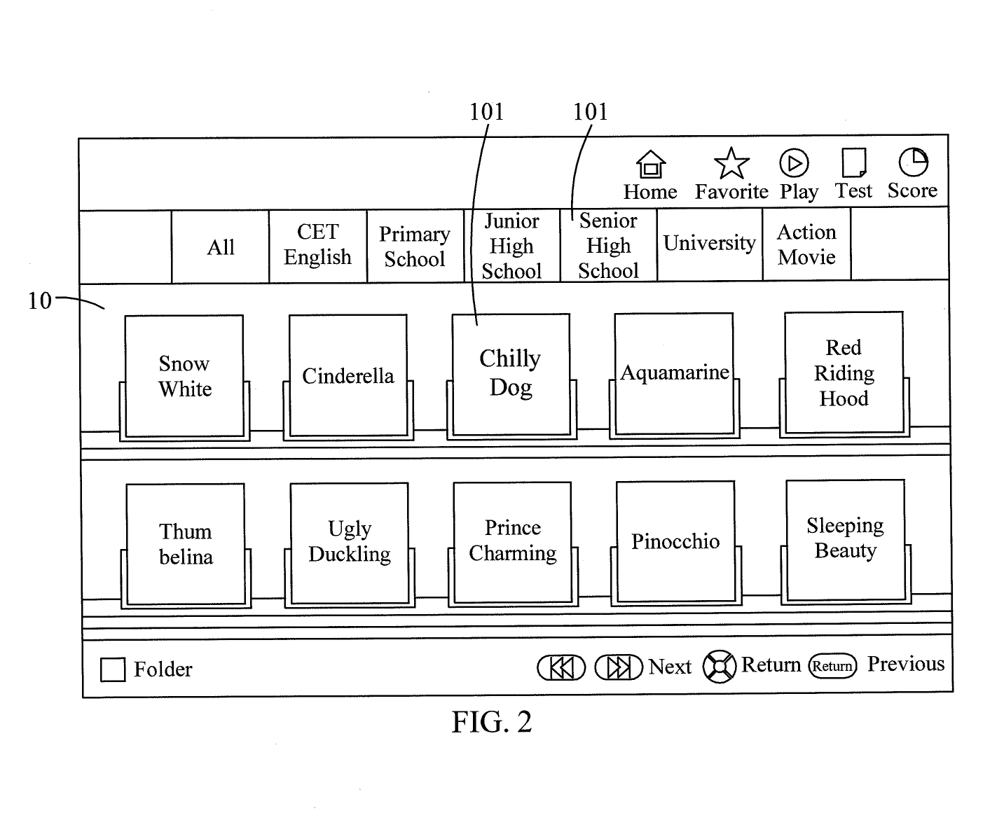

With reference to FIG. 2 for the first schematic view of an interactive type language learning platform system in accordance with a preferred embodiment of the present invention, the connection relation of components is similar to that described above, and thus will not be repeated. In FIG. 2, the learning interface 10 of the interactive type language learning platform system 1 includes a plurality of video options 101, wherein the plurality of video options 101 can be movie menu of different ratings (such as primary school, junior high school or senior high school). If one of the video options 101 is selected, a plurality of video data (such as a movie) is displayed corresponding the rating thereof. The plurality of video options 101 can be provided for selecting a movie directly. In this preferred embodiment, the movie menu of different ratings is used for illustrating the present invention only, but not intended for limiting the scope of the invention.

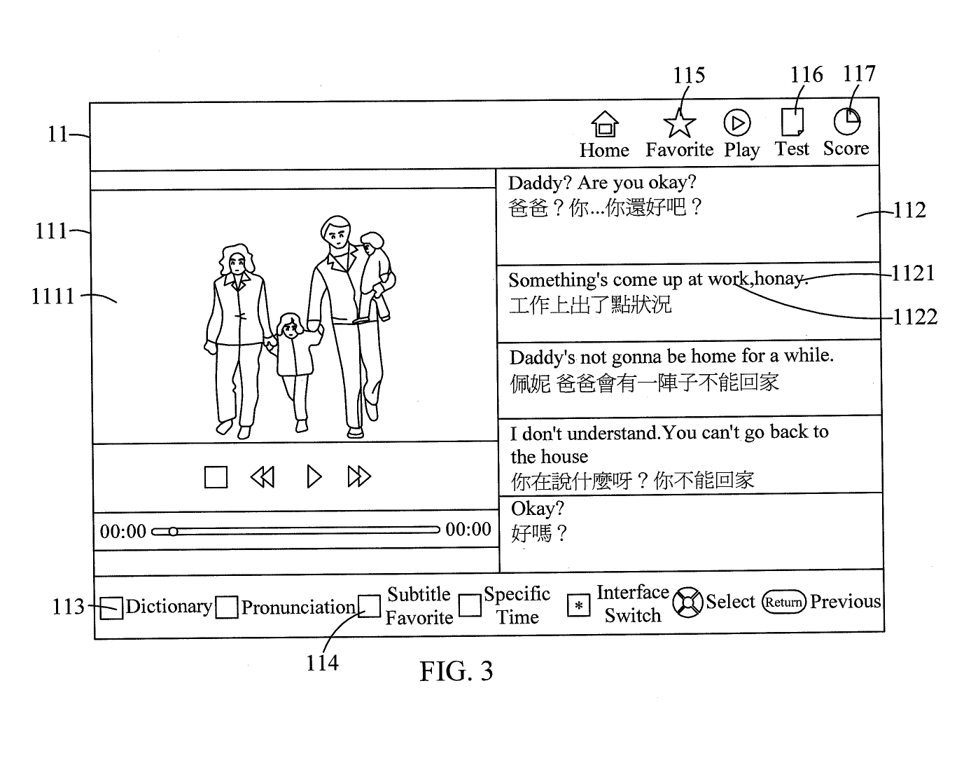

With reference to FIG. 3 for the second schematic view of an interactive type language learning platform system in accordance with a preferred embodiment of the present invention, if a user selects an option of junior high school rating and further selects one of the movie options from the options of the junior high school rating, and then the interactive type language learning platform system 1 downloads the video data 111 and multi-language subtitle data 1121 corresponding to the movie options from a storage unit or a remote database, and the video playback interface 11 displays the corresponding video data 1111 in the video display zone 111, and the plurality of multi-language subtitle data 1121 corresponding to the video data 1111 and a multi-language subtitle option 1122 corresponding to the plurality of multi-language subtitle data 1121 are displayed synchronously in the subtitle display zone 112. In this preferred embodiment, the multi-language subtitle data 1121 and the multi-language subtitle option 1122 are combined for the display, and such arrangement is provided for illustrating the present invention, but not intended for limiting the scope of the invention. Then, if the user uses a controller to control the video playback interface 11 to pause playing, the user can select the multi-language subtitle option 1122. After the user has completed the selection, a time position of the video data 1111 corresponding to the multi-language subtitle option 1121 are displayed in the video display zone 111, so that the user can play the video data 1111 anytime. It is noteworthy to point out that the user selects the multi-language subtitle option 1121 directly without pushing the pause button first, in order to switch to the playing mode.

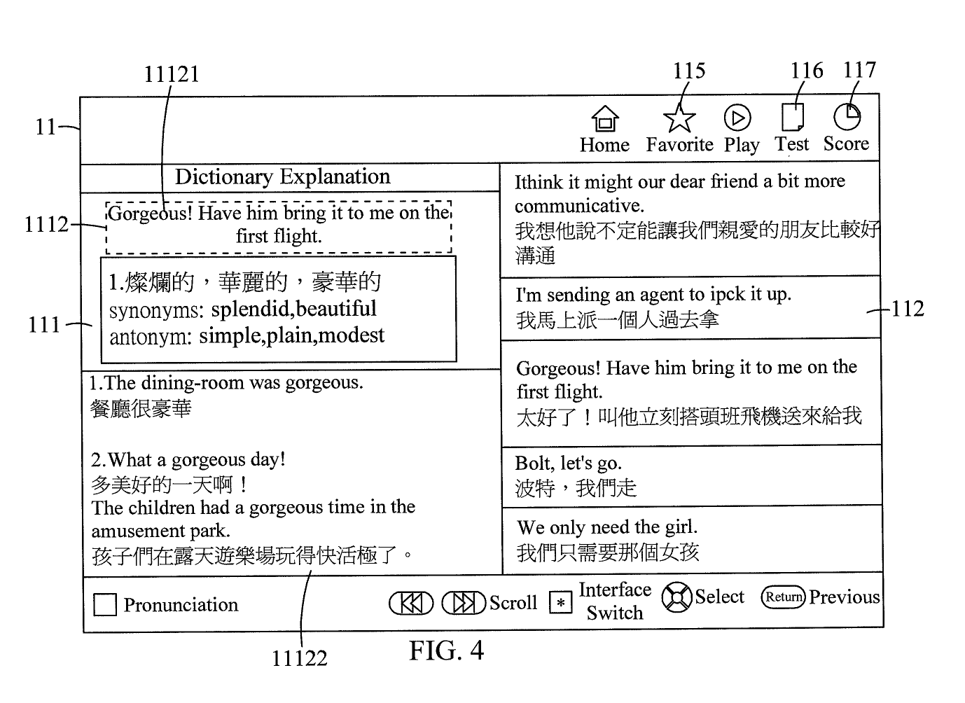

With reference to FIG. 4 for the third schematic view of an interactive type language learning platform system in accordance with a preferred embodiment of the present invention, the video playback interface 11 further comprises a dictionary option 113 to enter into a dictionary lookup function. When the user selects one of the multi-language subtitle options 1121, and then selects the dictionary option 113, the corresponding sentence data 1112 are displayed in the video display zone 111. Wherein, each of the sentence data 1112 comprises at least one vocabulary option 11121 and vocabulary data 11122 corresponding the at least one vocabulary option 11121 (wherein there are plural vocabulary options 11121 in this preferred embodiment). When the user selects one of the vocabulary options 11121, the video display zone 111 displays vocabulary data 11122 corresponding to the vocabulary option 11121, such as the explanation related to the vocabulary. If the user wants to end the dictionary lookup function, the user can select the dictionary option 113 once to end the lookup. The aforementioned method of ending the dictionary lookup function is provided for illustrating the present invention only intended for limiting the scope of the invention.

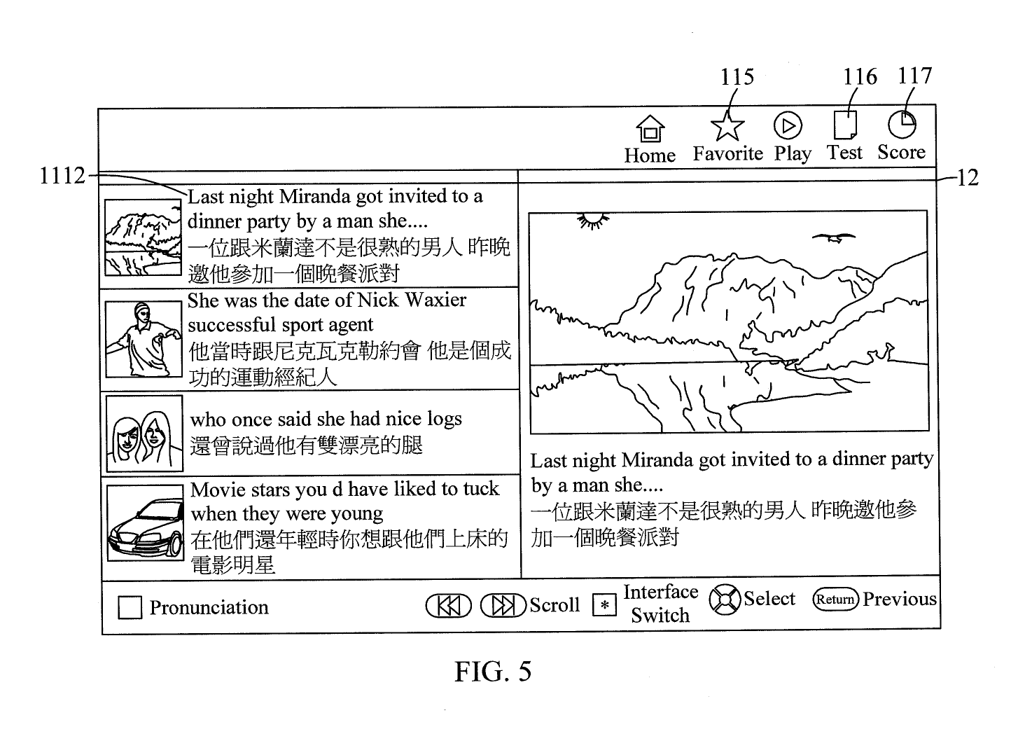

With reference to FIG. 5 for the fourth schematic view of an interactive type language learning platform system in accordance with a preferred embodiment of the present invention, the video playback interface 11 further comprises a favorite option 114. Besides the dictionary lookup function, the user can execute a subtitle favorite function, so that after the user selects one of the multi-language subtitle options 1121 and then selects the favorite option 114, the interactive type language learning platform system 1 will save the corresponding sentence data 1112 or multi-language subtitle data 1121 in a database (not shown in the figure) and used for revisions. If the user searches for a favorite subtitle, the user can select a favorite inquiry option 115 in the video playback interface 11 to connect to a look-up interface 12. The look-up interface 12 arranged for being executed from the storage device by the data processing device and displayed on at least a portion of the display device. In the look-up interface 12, the saved sentence data 1112 or multi-language subtitle data 1121 will be displayed and provided for the revision by the user. In a preferred embodiment, the sentence data 1112 or the multi-language subtitle data 1121 in the look-up interface 12 are provided for the user's selection to play the corresponding video and subtitle. It is noteworthy to point out that the user can use a control button of a remote control (not shown in the figure) to make a selection for the favorite inquiry, or a control option can be built in the video playback interface 11 for the control.

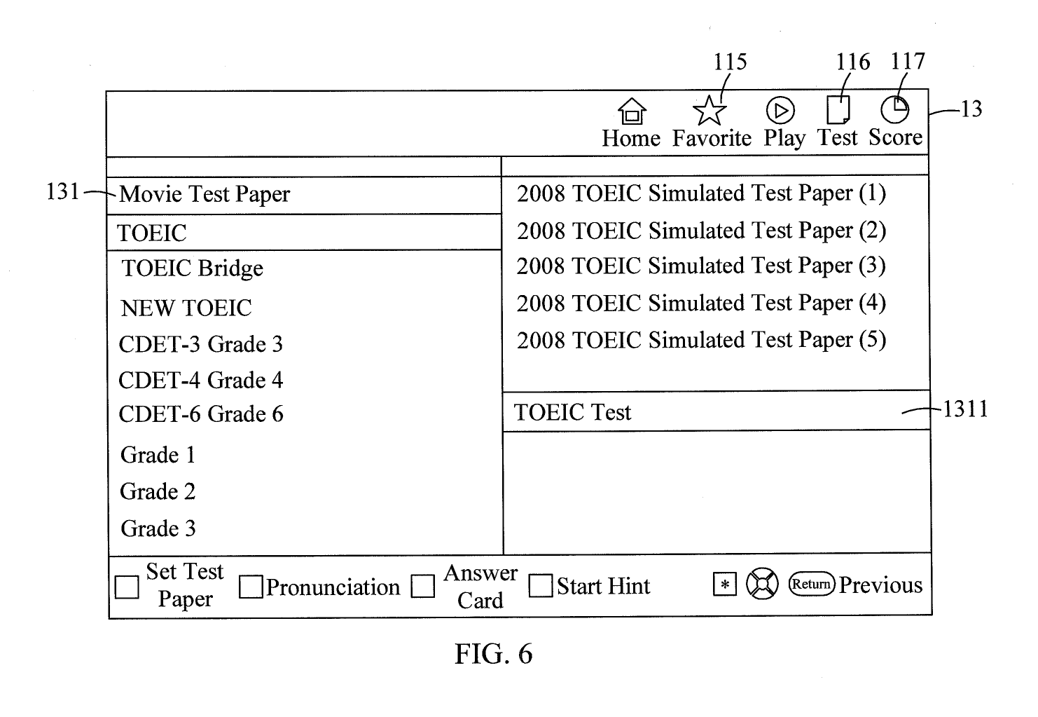

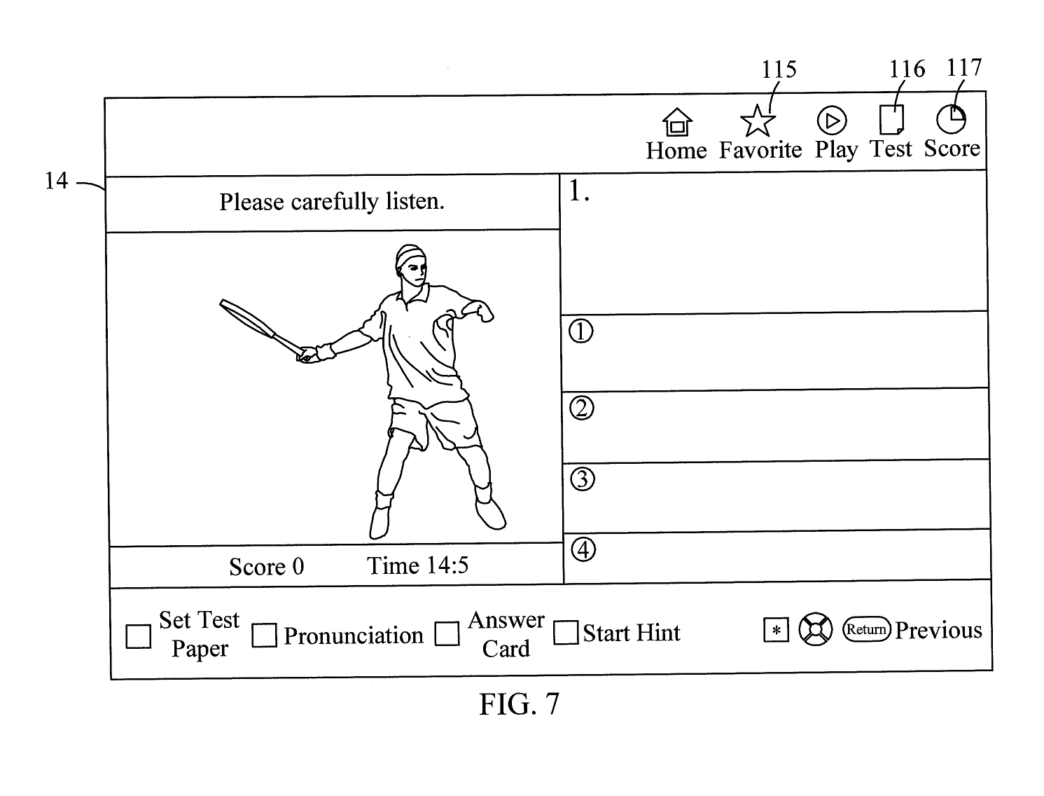

With reference to FIGS. 6 and 7 for the fifth and sixth schematic views of an interactive type language learning platform system in accordance with a preferred embodiment of the present invention respectively, after the user has learned to a certain stage, the user can execute a test practice function by selecting a test option 116 from the video playback interface 11 to connect to a selected test interface 13. The selected test interface 13 arranged for being executed from the storage device by the data processing device and displayed on at least a portion of the display device. The selected test interface 13 comprises a plurality of test subject options 131, which can be a test subject option 131 corresponding to all video data 1111 and a test subject option having preset test questions, such as a language test related to a movie, or preset test questions as specified by general language certifications. If the user further selects one of the test subject options 131, at least one test question option 1311 (wherein plural test question options 1311 are used for the illustration) will be displayed. Now, the user can select one of the test question options 1311 to connect to a test interface 14, arranged for be executed from the storage device by the data processing device and displayed on at least a portion of the display device, to carry out tests and practices.

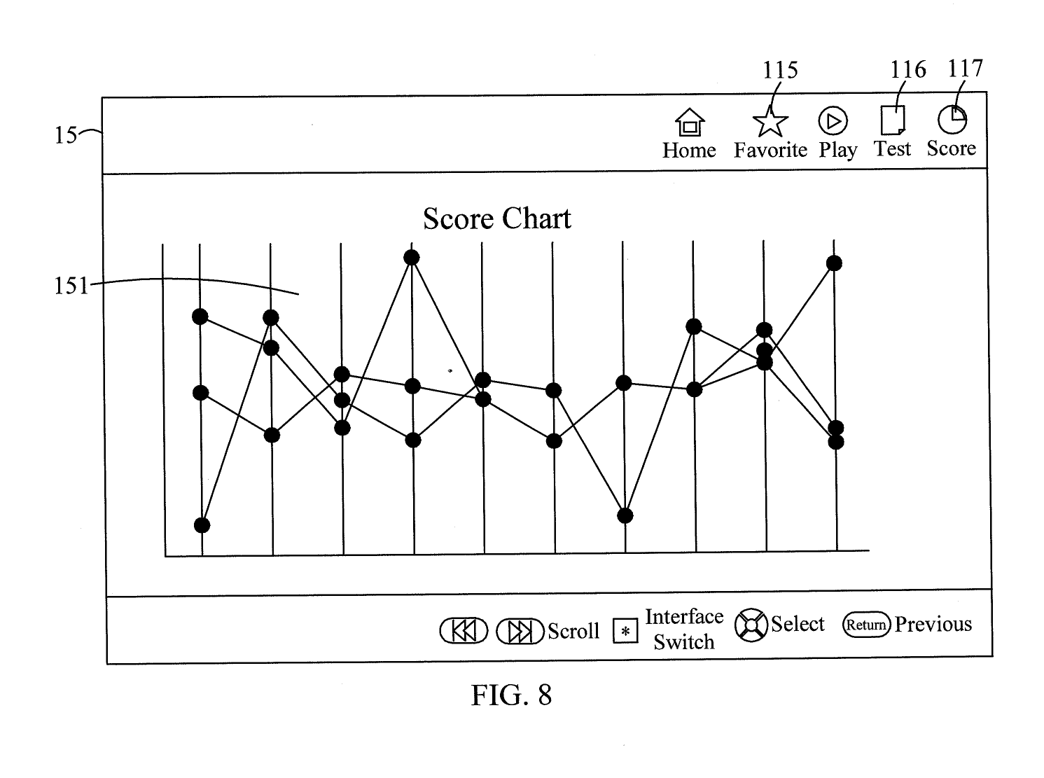

With reference to FIG. 8 for the seventh schematic view of an interactive type language learning platform system in accordance with a preferred embodiment of the present invention, after the user has taken one or more tests, the user can select a score inquiry option 117 from the video playback interface 11 to connect to a score interface 15 arranged for being executed from the storage device by the data processing device and displayed on at least a portion of the display device. In the score interface 15, score data 151 will be displayed, and the score data 151 refer to the score of a test taken by the user through the test interface 14. It is noteworthy to point out that the score data 151 can be the scores of all tests taken previously by the user, or one of the test scores, which can be in the form of a chart or a list, and not limited by the examples given in the figures only.

Generally, embodiments of the present invention employ various processes involving data stored in or transferred through one or more computers or data processing devices. Embodiments of the present invention also relate to apparatus and systems for performing these operations. The apparatus may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the required method steps. A particular structure for a variety of these machines will appear from the description given below.

In addition, embodiments of the present invention relate to computer program code, computer readable media or computer program products that include program instructions and/or data (including data structures) for performing various computer-implemented operations. Examples of computer-readable media include, but are not limited to, magnetic media such as hard disks, floppy disks, and magnetic tape; optical media such as CD-ROM disks; magneto-optical media; semiconductor memory devices, and hardware devices that are specially configured to store and perform program instructions, such as read-only memory devices (ROM) and random access memory (RAM). The data and program instructions of this invention may also be embodied on a carrier wave or other transport medium. Examples of program instructions include both machine code, such as produced by a compiler, and files containing higher level code that may be executed by the computer using an interpreter.

It is noteworthy that the interactive type language learning platform system further comprises a user interface provided for different users to log on and inquire their scores, but such technology is a prior art and will not be described in details.

Obviously, the present invention breaks through the prior art and achieves the expected effects, and complies with the patent application, and thus is duly filed for patent application.

What is claimed is:

1. An interactive type language learning platform system, applied to a display device by a data processing device and a storage device, comprising:
a learning interface, arranged for being executed from the storage device by the data processing device and displayed on at least a portion of the display device, the learning interface includes a plurality of video options;
a video playback interface, arranged for being executed from the storage device by the data processing device and displayed on at least a portion of the display device, the video playback interface includes a video display zone and a subtitle display zone, such that when one of the video options is selected, the selected video option is connected to the video playback interface, and the video display zone displays video data corresponding to the video option, and the subtitle display zone synchronously displays a plurality of multi-language subtitle data corresponding to the video data and a multi-language subtitle option corresponding to the plurality of multi-language subtitle data, and when one of the multi-language subtitle options is selected, the video display zone displays a time position of the video data corresponding to the multi-language subtitle option.

2. The interactive type language learning platform system of claim 1, wherein the video playback interface further includes a dictionary option, such that when the dictionary option and one of the multi-language subtitle options are selected, the video display zone displays sentence data corresponding to the multi-language subtitle option.

3. The interactive type language learning platform system of claim 2, wherein each of the sentence data includes at least one vocabulary option and vocabulary data corresponding to the at least one vocabulary option, and when the vocabulary option is selected, the video display zone displays the vocabulary data corresponding to the vocabulary option.

4. The interactive type language learning platform system of claim 2, wherein the video playback interface further includes a favorite option, such that when the favorite option and one of the multi-language subtitle options are selected, the sentence data or the multi-language subtitle data corresponding to the multi-language subtitle option are saved in a database.

5. The interactive type language learning platform system of claim 4, further comprising a look-up interface, arranged for being executed from the storage device by the data processing device and displayed on at least a portion of the display device, and the video playback interface further including a favorite inquiry option, such that when the favorite inquiry option is selected, the look-up interface is connected to display the sentence data or the multi-language subtitle data of the database.

6. The interactive type language learning platform system of claim 1, further comprising a selected test interface, arranged for being executed from the storage device by the data processing device and displayed on at least a portion of the display device, and the video playback interface further including a test option, such that when the test option is selected, the selected test interface is connected.

7. The interactive type language learning platform system of claim 6, further comprising a test interface, arranged for being executed from the storage device by the data processing device and displayed on at least a portion of the display device, and the selected test interface further comprises a plurality of test subject options, and each of the test subject option comprises at least one test question option, and the test question option being connected to the test interface.

8. The interactive type language learning platform system of claim 7, wherein the plurality of test subject options comprise the test subject option corresponding to the video data and the test subject option having a preset test question.

9. The interactive type language learning platform system of claim 8, further comprising a score interface, arranged for being executed from the storage device by the data processing device and displayed on at least a portion of the display device, and the video playback interface further comprising a score inquiry option for connecting to the score interface to display score data.

10. The interactive type language learning platform system of claim 9, wherein each of the score data comprises a score of a test taken by a user through the test interface.
